(19) United States
(12) Patent Application Publication
(10) Pub. No.: US 2013/0087950 A1
(43) Pub. Date: Apr. 11, 2013

(54) METHOD FOR OPERATING SEVERAL NEEDLE VALVE NOZZLES OF INJECTION-MOLDING EQUIPMENT

(71) Applicants: Herbert GÜNTHER, Allendorf (DE); Siegrid SOMMER, Burgwald (DE); Torsten SCHNELL, Lichtenfels (DE)

(72) Inventors: Herbert GÜNTHER, Allendorf (DE); Siegrid SOMMER, Burgwald (DE); Torsten SCHNELL, Lichtenfels (DE)

(73) Assignee: GUNTHER Heisskanaltechnik GmbH, Frankenberg (DE)

(21) Appl. No.: 13/617,031

(22) Filed: Sep. 14, 2012

(30) Foreign Application Priority Data
Oct. 5, 2011 (DE) 10 2011 054 214.0

(51) Int. Cl. B29C 45/23

(52) U.S. Cl. 264/402

(57) ABSTRACT

An injection-molding equipment includes at least two cavities and at least one needle valve nozzle, each fitted with one needle, per cavity. The needles are displaceable by an electromagnetic drive into an open and a closed position to respectively release and close a gate aperture subtended in the particular related cavity. Each electromagnetic drive has at least one electromagnet with each sealing needle axially held in place in the open and in the closed position by at least one permanent magnet. A control unit generates individual power pulses of which the duration is defined and saved in said control unit. An electromagnet of an electromagnetic drive is fed a power pulse and generates an electromagnetic field to displace the sealing needle from its closed into its open position and vice-versa, with the power pulses for at least two electromagnetic drives being transmitted in time-staggered manner to the drives.

The present invention relates to a method for operating several (sealing-) needle valve nozzles in injection-molding equipment as defined in the preamble of claim 1.

Injection molding equipment is used to manufacture injection-molded parts, in particular plastic parts made from a flowable material injected into a mold (also called cavity) wherein it hardens to at least some extent. Injection-molding equipment also are known which are fitted with one or more cavities.

A problem is encountered with multi-cavity injection-molding equipment, namely that the individual cavities are filled at different rates with said flowable material being fed into them. As a result, either some cavities will fill to capacity fairly early and are pressurized for an extended time while other cavities are not yet filled to capacity, as a result of which the plastic parts being made shall be too lightweight or are not fully completed. The waste therefore is very high and manufacturing costs rise.

To remedy such drawbacks, it is known for instance from the EP 0 468 485 A2 patent document to balance the flow ducts within the injection-molding equipment, in particular within the manifold, that is, the nozzle flow ducts and the manifold ducts are so designed within the injection-molding equipment with respect to their configuration, their diameter and their orientation, that the cavities shall be filled with the flowable material as much as possible at the same speed. Such designs however entail substantial calculations when designing the injection-molding equipment. Also, the design latitude of the injection-molding equipment is restricted. Again, when the flowable material is replaced by one of different properties, the desired balancing is lost and the injection-molding equipment must be recalculated and be exchanged at least partly, and consequently changing the material to be processed—entailed by different design requirements for instance of color, touch or mechanical strength—is made more difficult and frequently requires changes in the mold.

Alternatively or in addition to balancing, U.S. Pat. No. 3,491,408 A stipulates that each injection molding nozzle be fitted within the injection-molding equipment with a valve element that may be moved into an open or closed position and each valve element being fitted with a manually adjustable threaded stop to set/adjust the open position. In this manner the flow cross-section of each injection-molding nozzle feeds during each operational cycle an accurately defined quantity of the flowable material into the particular associated cavity. As a result these cavities always are filled uniformly.

While the above cited remedies lead to useful results, they incur however operator errors in practice. In particular said threaded stops might be reset deliberately or unwittingly by untrained personnel, so that the injection-molding equipment must be readjusted. Usually such endeavors require elaborate tests to ascertain the individual cavities' filling levels. Also, these tests must be carried out even when only one injection-molding nozzle must be exchanged because even in such an occurrence the system must readjusted and rebalanced. The latter condition also applies to changing the flowable material or exchanging a molding inset. Even then the system must readjusted across the individual valves. Accordingly such a remedy is bothersome in practice when frequently changing the color or material.

The European patent document EP 1 013 395 A1 also uses injection-molding nozzles of which the valve elements may be adjusted by means of displaceable stops to allow individually setting the flow cross-sections of the particular injection-molding nozzles. However each such stop is designed in a way to be adjustable during an opening cycle. In this manner the flow per unit time of the flowable material may be varied during the open position of a sealing needle. This system is exceedingly complex throughout and therefore susceptible to damage and it is costly.

The objective of the present invention is to overcome the above cited drawbacks of the state of the art and to offer a solution involving simple, economical means and making possible uniformly filling the cavities of injection-molding equipment with a flowable material. Furthermore the invention relates to achieving flexible and simple handling as well matching quickly and in problem-free manner a change in materials, molds and/or parameters.

The main features of the invention are defined in claim 1. Embodiment modes are defined in claims 2 through 11.

In a method for operating several (sealing) needle valve nozzles of an injection-molding equipment, the present inventions calls for the following features:
an injection-molding equipment comprising at least two cavities and at least one needle valve nozzle per cavity,
each needle valve nozzle comprises a sealing needle which may be displaced into an open and a closed position by means of an electromagnetic drive for the purpose of releasing and closing a gate aperture subtended in the related cavity,
each electromagnetic drive comprises at least one electromagnet,
each sealing needle is axially kept in the open position and in the closed position by at least one permanent magnet,
a control unit of the injection-molding equipment generates individual current pulses, hereafter “power pulses”, for each electromagnetic drive of the needle valve nozzle,
the duration of the power pulses is defined and saved in the control unit,
an electromagnetic drive's electromagnet, when fed a power pulse, generates an electromagnetic field overcoming the force between the sealing needle and the permanent magnet and displacing the sealing needle from the closed into the open position or vice-versa,
the power pulses of at least two electromagnetic drives are transmitted to these in time-staggered manner.

Using electromagnetic drives allows directly displacing the associated needle. Accordingly only minute mechanical inertias need being overcome, making feasible high switching rates. A needle controlled in this manner may be moved from an open into a closed position and back within a few hundredths of a second. These very short adjustment times allow filling a cavity as a function the needle-open time interval. In order that at least two cavities be filled in ideal manner, the invention provides that the power pulses from at least two electromagnetic drives be applied in time-staggered manner to said cavities. In this way the open time interval of each sealing needle can be controlled accurately and balancing may be effectively complemented or replaced.

The electronic control allows archiving stored data and illustratively to relate them to given materials and mold parts. Where changes in color, material or mold are concerned, these data may be retrieved rapidly any time. Accordingly, laboriously adjusting manually both each needle valve nozzle and its stops no longer is required. Also the stored data may be password-protected, whereby only restricted personnel may alter said data. No longer may unauthorized personnel—whereby only restricted personnel may alter said data, deliberately or not—adjust said needles. No longer may unauthorized personnel—whether deliberately or not—adjust said needles.

Also, the method of the invention makes it possible to save the duration of the control unit's power pulses in said control unit. Depending on the adhesion/friction between the needle and a flowable material, the pulse duration then may be reduced to a minimum, said needle still being displaceable from one end position into the other.

In a further embodiment mode of the prevent invention, the power pulses are transmitted—by time-staggered opening time and/or closing time deltas which are defined and stored in the control unit—to at least two electromagnetic drives. The opening time deltas and/or the closing time deltas of the second cavity may be selected relative to the first cavity's power pulses, or said deltas are determined from the differential between the absolute time values of a power pulse from a first electromagnetic drive and one from a second electromagnetic drive. Where only one opening time delta is provided, the opening time relationship of the two electromagnetic drives ceases to exist and their closing times are identical. If there is only a closing time delta provided, the closing time relationship of the two electromagnetic drives ceases to exist and their opening times are identical. On the other hand, if an opening time delta and a closing time delta are present, both the opening time value and the closing-time value of the electromagnetic drives differ.

In yet another embodiment of the invention, the power pulses fed to an electromagnetic drive are opening power pulses moving a sealing needle from a closed into an open position, and closing power pulses of opposite current direction serve to displace a sealing needle from an open into a closed position, the opening power pulses and/or the closing power pulses being transmitted in time-staggered manner at least to two electromagnetic drives. An electromagnetic field from an electromagnet may be reversed by splitting the power pulses into opening power pulses and closing power pulses. Accordingly a single electromagnet per electromagnetic drive suffices to displace the needle into the open and into the closed positions. As a result, the electromagnetic drive may be made compact and its manufacturing costs will be minimal.

The opening power pulses may be transmitted at defined opening time deltas saved in the control unit, and/or the defined closing power pulses saved in said control unit may be transmitted at a defined closing time delta also saved in said control unit, said transmissions taking place in time-staggered manner to at least two electromagnetic drives. The opening time deltas and the closing time deltas of the second cavity again may be selected relative to the opening power pulse/closing power pulse of the first cavity, or they may result from the differential of the absolute time values of an opening power pulse/closing power pulse of a first electromagnetic drive and that of a second electromagnetic drive. Where only one opening time delta is provided, the opening time value of the two electromagnetic drives differ and their closing time values are the same. In the case of one opening time delta, the electromagnetic drives open simultaneously and their closing times differ. Where one opening time delta and one closing time delta are present, both the opening time value and the closing time value of the electromagnetic drives differ.

The opening time delta and/or the closing time delta may be selected within the control unit in a manner that the cavities may be filled with an ideal quantity of flowable material. Some topping off feeding may be used until all cavities are filled as desired. In this way one may compensate for poor balancing of the injection molding equipment, or else balancing is implemented completely by means of the opening and closing time deltas. Where intermediate feeding test results are saved, they can easily be downloaded again. In the event of adjustments during such tests should go in the wrong direction, one may easily revert to a previously save adjustment. In this manner the top-off tests require much less time than is needed with manually adjustable injection molding nozzles.

Because of the electronic drives' high speed of adjustment, advantageously the opening time delta and/or the closing time delta are saved in the control unit with an accuracy of 1/100 seconds or better. In this manner the maximum speed of adjustment may be exploited fully, and the duration of injection of the individual needle valve nozzles can be defined very sharply.

Additionally, sensors may detect the cavities' filling levels and the opening time deltas and/or closing time deltas are computed by the control unit and/or matched to them. This procedure substantially reduces manual top-off tests determining the opening time deltas and/or the closing time deltas or replacing them. Also the proper operation of injection molding may be monitored during production and when required the opening time deltas and/or the closing time deltas may be corrected. Illustratively an ideal pressure function might be saved in the control unit and the actual pressure function would be determined by pressure detectors in the cavity during a production cycle and be compared to the ideal pressure function. If deviations are found, the control unit might correct the opening time deltas and/or the closing time deltas. In this instance the control unit's required computing capacity may be substantially less than when exclusively controlling by means filling tests and a high accuracy and uniformity of the molded items is attained. Also, the control unit may detect mold damage on account of such deviations and an error message may be issued.

The invention offers special advantages when separate opening time deltas and/or closing time deltas for different injection molding scenarios are saved in the control unit and one of injection molding scenarios is selected. Such injection molding scenarios in particular may be different flowable materials, or different cavity insets, or deactivation of at least one cavity. In the state the of the art, all nozzles are required being individually readjusted ahead of each change in injection molding scenario. By saving the scenarios in the control unit in the manner of the invention, said scenarios can be downloaded in simple manner and as often as needed, and changing scenarios is very fast and simple.

Illustratively plastic parts to be produced with a recess or lacking one, for instance being used for automobile door finishing as manual and/or electronic window drives, can be made in simple manner by means of a mold inset and a change in scenario resorting to said control unit.

Moreover top-off tests may be carried out and the pertinent adjustments may be stored. After checking the components—a procedure that for lab tests may well stretch out (several weeks), the best scenario may be selected for the next production run.

Conceivably the control unit may be fitted with a deactivation unit for each single cavity and/or for each electromagnetic drive. By selecting an appropriate scenario in the control unit, the remaining cavities are balanced very rapidly and reliably, and accordingly the proper quantity of flowable material reaches each of these cavities.

Preferably each sealing needle is fitted with an armature corresponding to the permanent magnets and electromagnets. The mass of such an armature is sufficient to respond to a magnetic field. Therefore the armature should at least partly be composed of a magnetizable material. Also each armature may subtend stop surfaces which by means of appropriate stops limit the excursions of said needles. This design allows accurately defining the cross-sectional gate aperture and hence the flow quantity of the flowable material in the open and closed position. Alternatively, however, stop elements independent of said armature also may be used.

Every armature may be fitted with an armature magnet cooperating with the permanent magnets and the electromagnets. In this manner the total magnetic acceleration and retention force is not generated by the permanent magnets and the electromagnets, instead their magnetic fields are reinforced by the armature magnet. This design makes possible especially brief switching times from the open into the closed positions and vice-versa, as a result of which the injected quantity of flowable material per cavity also can be set very accurately.

In a further embodiment mode of the invention, the needle valve nozzles are connected in fluid flow with the nozzle flow ducts and latter by means of a common manifold. This design allows feeding by means of a single means the flowable material to the needle valve nozzles. Such a single means is more economical than a plurality of them for each cavity, and its complexity and susceptibility to defects are low. The manifold allows a balancing procedure of which any inaccuracies and lack of flexibility may be compensated by the method of the invention.

To make the needle valve nozzle and the electromagnetic drive as compact as possible, the permanent magnets ideally would be an element of the said drive.

User friendliness of the method of the invention may be further enhanced by additional operational modes. Illustratively the control unit might store the number of open positions and/or closed positions of the sealing needles, preferably for each individual cavity. This feature makes available information about how many injection-molded items already have been manufactured, and this knowledge may then determine for instance the mold's maintenance schedule. Where individual cavities are partly deactivated, such deactivations also may be distributed uniformly among the cavities, whereby the individual cavities will wear uniformly. Again documenting the hours of mold service by means of the control unit may be helpful to the user.

Further features, particulars and advantages of the present invention are defined in the claims and in the description below of illustrative embodiment modes in relation to the appended drawings.

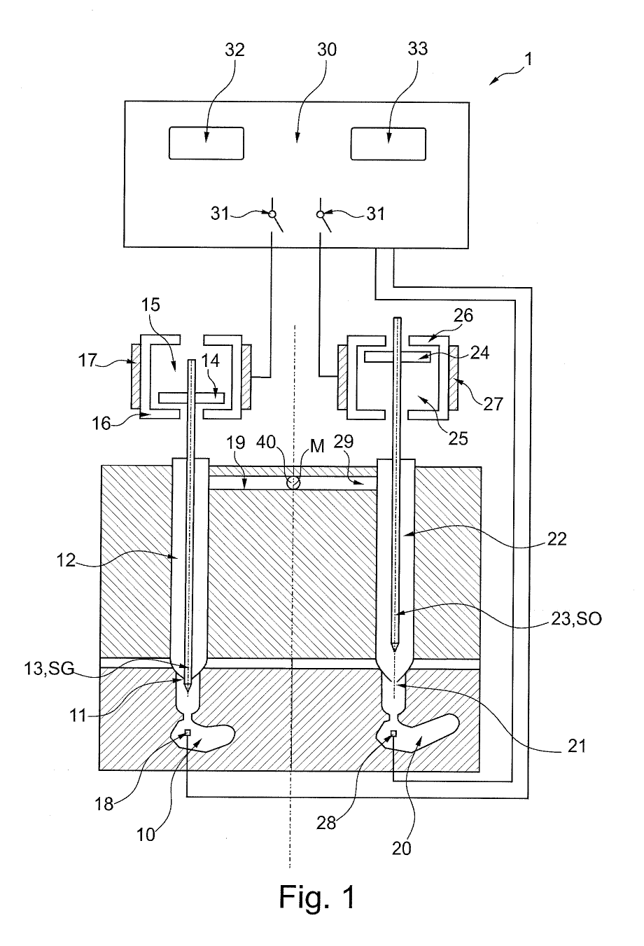

FIG. 1 shows an ejection molding equipment comprising a control unit and two cavities each fitted with a needle valve nozzle;

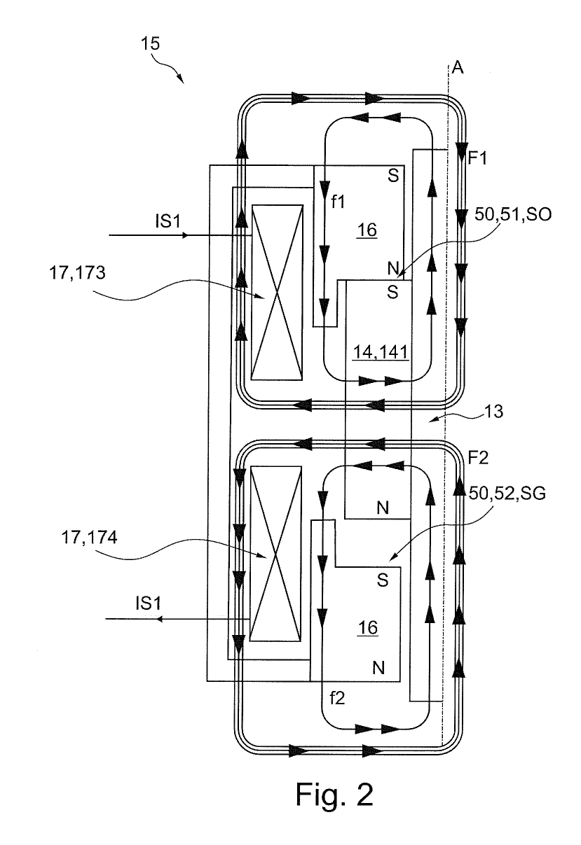

FIG. 2 shows an electromagnetic drive fitted with two permanent magnets and a sealing needle which comprises an armature with an armature magnet;

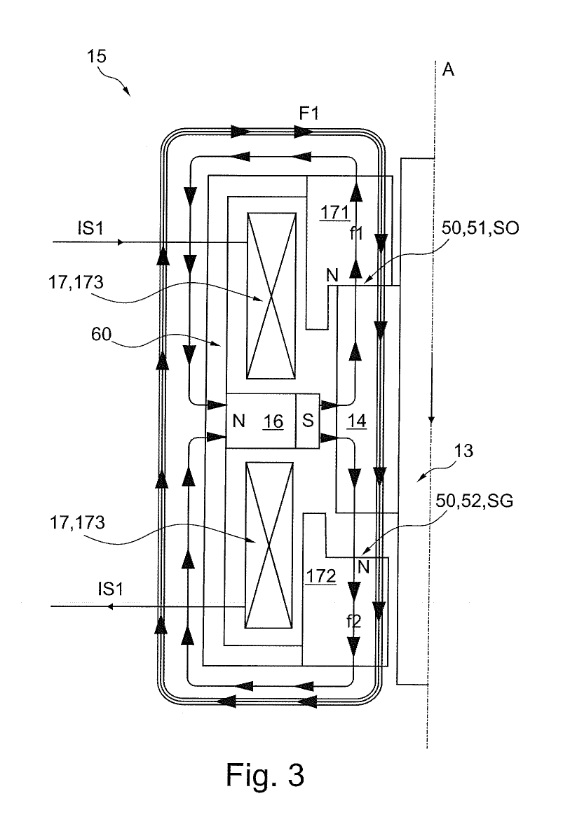

FIG. 3 shows an electromagnetic drive fitted with one permanent magnet and two cores, further a sealing needle with an armature; and

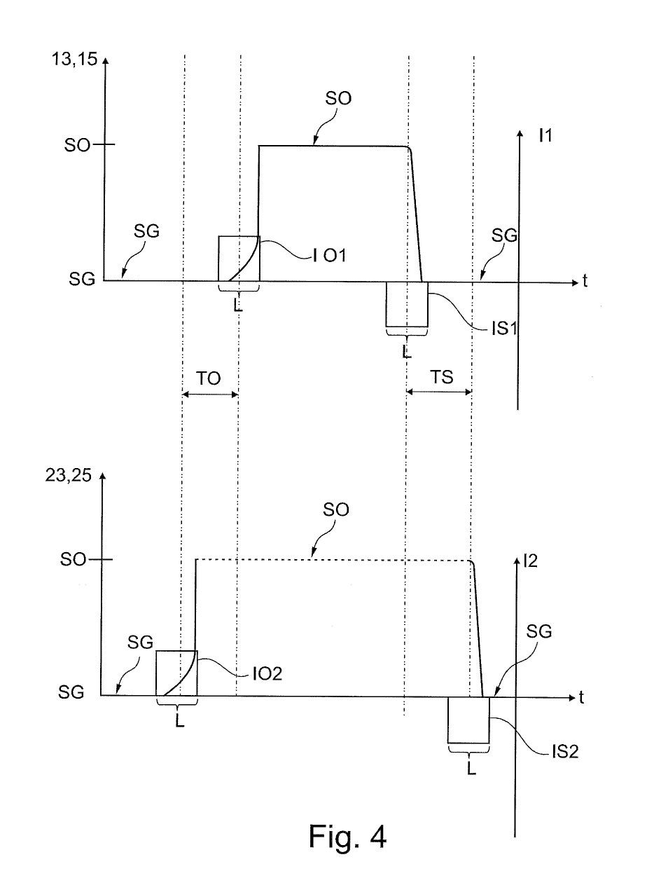

FIG. 4 is a plot representing the open position and closed position of a first and a second electromagnetic drive, also the power pulses generated from a control unit and fed to said drives.

FIG. 1 shows an injection molding equipment 1 with two cavities 10, 20 each fitted resp. with a sealing needle valve nozzle 12, 22. Each needle valve nozzle 12, 22 is fitted with a sealing needle 13, 23 that may be displaced by an electromagnetic drive 15, 25 into an open position SO resp. into a closed position SG for the purpose of opening and closing a gate aperture 11, 21 present in the associated cavity 10, 20. In this figure, the first sealing needle 13 is in a closed position SG and the second sealing needle 23 is in an open position SO.

To allow feeding a flowable material M into the cavities 10, 20 when in their open position SO, the needle valve nozzles 11, 21 are connected in a way to allow flow by nozzle feed ducts 19, 29 and by means of latter through a common manifold 40.

The electromagnetic drives 15, 25 each are fitted with an electromagnet 17, 27, and each sealing needle 13, 23 comprises an armature 14, 24 linked to allow displacement. Both in the open position SO and in the closed position SG, the sealing needles 13, 23 are kept in the axial direction by permanent magnets 16, 26. This configuration is implemented in particular here by the armature 14, 24 cooperating with the permanent magnets 16, 26 and the electromagnets 17, 27.

A control unit 30 is fitted with a display 32, an operating unit 33 and a deactivation element 31. Individual power pulses I1, I2 can be generated by the control unit 30 of the injection molding equipment 1 for each electromagnetic drive 15, 25 of the needle valve nozzles 12, 22. The power pulses I1, I2 evince a defined pulse duration L saved in the control unit 30 and controlled by the operating element 33. Said pulse durations are protected by administrator rights to preclude unauthorized alteration.

An electromagnet 17, 27 of an electromagnetic drive 15, 25 and receiving a power pulse I1, I2 generates a magnetic field as a result of which the force between the sealing needle 13, 23 and the permanent magnet 16, 26 is overcome and the sealing needle 13, 23 is displaced from the closed position SG into the open position SO or from the open position SO into the closed position SG. In order to attain completely filling the cavities 10, 20 with the flowable material M and in the course of an optimal molding cycle, the power pulses I1, I2 are transmitted in time staggered manner to the electromagnetic drives 15, 25. In particular the power pulses I1, I2 are selected for the electromagnetic drives 15, 25, the opening power pulses IO1, IO2 to move a sealing needle 13, 23 from a closed position SG into an open position SO, or closing power pulses IS1, IS2 with reversed power/current direction to displace a sealing needle 13, 23 from an open position SO into a closed position SG.

In the process, the opening power pulses IO1, IO2 and the closing power pulses IS1, IS2 are transmitted in time-staggered manner to the electromagnetic drives 15, 25. In particular, the opening power pulses IO1, IO2 saved in the control unit 30 are transmitted in time-staggered manner at defined opening time deltas TO and/or the closing power pulses IS1, IS2 saved in the control unit 30 are transmitted in time staggered manner at defined closing time deltas TS to the electromagnetic drives 14, 24. Both the opening time deltas TO and the closing time deltas TS are saved in the control unit and may be altered by means of the operating element 33. To preclude unauthorized alterations, they are again protected by administrator rights. The opening time delta TO and the closing time TS may be adjusted within the control unit 30 at an accuracy as good or better than 1/100 seconds in a manner that the cavities 10, 20 shall be filled with an ideal quantity of flowable material M during an open position SO of the sealing needles 13, 23.

Furthermore, by means of the sensors 18, 28 configured in the cavities 10, 20, the control unit 30 monitors said cavities' filling levels and moderately matches the opening time deltas TO and the closing time deltas TS. In other words, the sealing needles indeed are not controlled by means of the filling level measurement, but intervention takes place only thereafter during the ensuing molding cycles by the opening time deltas TO and the closing time deltas TS being modified slowly and cautiously if the filling level measurement were to deviate from optimal. This optimum state illustratively may be saved in the form of a pressure-time graph in the control unit, the sensors 18, 19 being pressure detectors.

Lastly the operating unit 33 may be selected from different injection-molding scenarios saved in the control unit 30. The injection-molding scenarios include separate opening time deltas TO and closing time deltas TS, so that different materials with different viscosities may be topped off. Also the deactivation element 31 is situated in the electrical connection to the electromagnets 17, 27. This deactivation element 31 is able to entirely deactivate an associated electromagnet 17, 27 and as a result the manufacture of injection molded parts may be continued while excluding one or more cavities.

FIG. 2 illustrates an embodiment mode of an electromagnetic drive 15 fitted with a sealing needle 13 comprising an armature 14. This view is a cross-section obtained by rotation about an axis of rotation A of a substantially rotationally symmetrical electromagnetic drive 15. The symmetry of rotation excludes in particular electrical lines.

The armature 14 of the sealing needle 13 is an armature magnet 141 having two poles N,S. Two permanent magnets 16 also comprising two poles N,S are configured in the axial direction of the axis of rotation A toward the armature 14. All poles N,S run axially relative to the sealing needle 13. In particular, the permanent magnet 16 shown at the top of FIG. 2 points by its north pole N toward the armature magnet 141 below, of which the south pole S points toward the first permanent magnet 16. The first permanent magnet 16 constitutes an excursion stop 50 in the form of an opening stop 51, as a result of which the armature 14 and permanent magnet 16 are abutting each other in the shown open position SO of the sealing needle 13.

The second permanent magnet 16 is configured axially below the armature 14 and points by its south pole S toward the armature 14. The second permanent magnet 16 also constitutes an excursion stop 50, which however is a closing stop 52.

A first coil 173 of an electromagnet 17 is configured radially to the upper first permanent magnet 16. A second coil 174 running in the opposite direction is configured radially to the second permanent magnet 16. As already discussed above, the sealing needle 13 is in an open position SO. When in this position, the armature magnet 141 rests by its south pole S against the upper first permanent magnet 16. A first permanent magnet field f1 built up between said armature magnet 141 and the upper first permanent magnet 16 keeps the sealing needle 13 in the open position SO. On account of the gap between the south pole S of the second lower permanent magnet and the north pole N of the armature magnet 141, the force exerted in the direction of closing SG by a permanent magnet field f2 is insufficient to displace the sealing needle 13 into the closed position SG.

By means of a first closing power pulse IS1, the first coil 173 generates the upper first electromagnetic field F2 which is superposed on the first permanent magnetic field f1, resulting in the sum of magnetic fields in the direction of the electromagnetic field F1. As a result the poles N, S of the upper permanent magnet 16 are inverted. The armature magnet 141 is thus repelled by the upper permanent magnet 16 and moves in the direction of the closed position SG. Additionally, the lower second coil 174 reinforces by its electromagnetic field F2 the lower second permanent magnetic field f2. As a result, the armature magnet 141 also is attracted in the direction of the lower second permanent magnet 16. Consequently a very rapid displacement of the sealing needle 13 from the open position SO into the closed position SG is attained.

If on the other hand the sealing needle 13 should be displaced from the closed position SG into the open position SO, an opening power pulse OS1 opposite the closing power pulse IS1 is fed through the coils 173, 174. An upper electromagnetic field generated next acts oppositely the shown direction. Similarly a lower generated electromagnetic field points opposite the shown direction. As a result, the sum of the first permanent magnetic field f1 and the upper electromagnetic field is larger than the sum of the second permanent magnetic field f2 and the lower electromagnetic field. Also, the poles N,S of the lower permanent magnet 16 invert because of the second electromagnetic field F2. As a result the lower permanent magnet 141 repels the armature magnet 141 and the upper permanent magnet 16 attracts this armature magnet 141. Therefore the sealing needle 13 connected to the armature 14 is displaced from the closed position SG into the open position SO.

FIG. 3 shows another embodiment mode of an electromagnetic drive 15 comprising a sealing needle 13 itself fitted with an armature 14. The shown elevation is a cross-section which by rotation about an axis of rotation A will subtend a very substantively rotationally symmetric electromagnetic drive 15. Electrical wiring in particular is excluded from said symmetry of rotation.

Two cores 171, 172 of the electromagnetic drive 15 are configured axially along the axis of rotation A toward the armature 14. The first core 171 constitutes an excursion stop 50 in the form of an opening stop 51, as a result of which the armature 14 and the core 171 abut each other in the shown open position SO of the sealing needle 13. The second core 172 is configured axially underneath the armature 14. This second core 172 also constitutes an excursion stop 50, however being a closing stop 52.

A first coil 173 of an electromagnet 17 is configured radially to the first core 171. A second coil 174 running in the same direction is configured radially to the second core 172. A magnetizable housing 60 connects the two cores 171, 172 and encloses the coils 173, 174, Also, a permanent magnet 16 is configured between the two coils. The poles N,S of said permanent magnet 16 point radially to the axis of rotation A. In particular the north pole N rests against the housing 60 whereas the south pole S is slightly spaced from the armature 14.

As already discussed above, the sealing needle 13 is in an open position SO. In that configuration, the armature 14 and the upper first core 171 abut each other. Due to first core 171 making contact by means of the housing 60 with the permanent magnet 16, the core 171 constitutes a north pole N. A first permanent magnet field f1 subtended between the core 171 and the armature 14 keeps the sealing needle 13 in the open position SO.

By means of the housing 60 and the second core 172, the permanent magnet 16 subtends a further permanent magnet field f2, the second core 172 constituting a north pole N. Due to the spacing between the second core 172 and the armature 14, the force exerted by this second lower permanent magnet field f2 on the armature 14 is less than that of the first permanent magnet field f1. Accordingly the sealing needle 13 remains in the open position SO.

An electromagnetic field F1 is generated by the coils 173, 174 only when there is a first closing power pulse IS1. Said field F1 is superposed on the first permanent magnet field f1 in the opposite direction, thereby at least partly neutralizing said permanent magnet field f1.

The electromagnetic field F1 also is superposed on the lower second permanent magnet field f2 in the same direction, as a result of which the sum of the lower permanent magnetic field f2 and the electromagnetic field F1 is larger than the sum of the first permanent magnet field f1 and the electromagnet field F1. Consequently the armature 14 is attracted from the lower core 172. Thus the armature 14 is displaced from the first upper permanent magnet 16 toward the closed position SG.

If on the other hand the sealing needle 13 should be displaced from the closed position SG into the open position SO, a closing power pulse directed opposite the closing power pulse IS1 is fed through the coils 173, 174. The resulting electromagnetic field acts oppositely the shown direction. In this manner, the sum of the first permanent magnet field f1 and the electromagnet field is larger than the sum of the second permanent magnet field f2 and this electromagnet field. Accordingly the sealing needle 13 connected to the armature 14 is displaced from the closed position SG into the open position SO.

FIG. 4 is a plot comparing the open positions SO and the closed positions SG of two sealing needles 13, 23 that are actuated by a first electromagnetic drive 15 and a second electromagnetic drive 25. The abscissa is time.

The time abscissa t situated at the top of the FIG. 4 relates to two ordinates. The first ordinate (left in the figure) shows the adjustment of the first electromagnetic drive 15 resp. of the first sealing needle 13 of which the closed position SG and the closed position SO are indicated. The second ordinate data (at the right of figure) include first power pulses I1 transmitted from a control unit to the first electromagnetic drive 15.

When considering the chronology of the plot, the sealing needle 13 displaced by the first electromagnetic drive 15 when said needle initially is in a closed position SG. Then the control unit transmits a first opening power pulse IO1 to the first electromagnetic drive 15, said pulse being of a duration L. This pulse duration L is defined in the control unit and runs between 0.1 and 0.5 seconds, during which the first sealing needle 13 is in the open position SO. It remains in this position until the control unit transmits a first closing power pulse IS1 to the first electromagnetic drive 15. The duration of the latter closing power pulse also is L. During this pulse duration L, the first sealing needle 13 returns into its closed position SG.

Two ordinates are also associated with the time abscissa t at the bottom of FIG. 4. The adjustment path of the second electromagnetic drive 25 resp. of the second sealing needle 23 is plotted on the first ordinate (left in the Figure), in particular said needle's closed position SG and open position SO being so denoted. The data of the second ordinate (right in the Figure) include two second power pulses I2 which are transmitted from the control unit to the second electromagnetic drive 25.

It is clear from the chronology of the shown plot that the sealing needle 23 displaced by the second electromagnetic drive 25 initially is in its closed position SG. Then the control unit transmits a second opening power pulse 102 of duration L to the second electromagnetic drive 25. This duration is defined within the control unit and lies between 0.1 and 0.5 seconds. The second opening power pulse is time-staggered by an open time delta TO relative to the first opening power pulse IO1 transmitted to the first electromagnetic drive 15. In particular it will be transmitted prior to the first opening power pulse IO1.

The second sealing needle 23 moves into the open position SO within the pulse duration L of the second opening power pulse IO2. Said needle remains in the closed position SG until the control unit transmits a second closing power pulse IS2 to the second electromagnetic drive 25. Said pulse IS2 also exhibits a duration L. The second closing power pulse IS2 is time staggered by a closing time delta TS relative to the first closing power pulse IS1 transmitted to the electromagnetic first closing power pulse IS1. In particular it is transmitted after the first closing power pulse IS1.

Due to this chronologically accurate selection of the positions SO, SG of the sealing needles 13, 23 by means of the time-staggered power pulses I1, I2, each cavity in a mold may be filled completely and in this manner optimal injection molded articles can be manufactured. Illustratively imperfect balancing of a manifold may be corrected or the balancing may be exclusively carried out by controlling the sealing needles 13, 23.

The present invention is not restricted to any of the above discussed embodiment modes, instead it may be modified in versatile manner. In particular more than only two needle valve nozzles and/or cavities may be operated.

All features and advantages, inclusive design details, spatial configurations and procedural steps, explicit and implicit from the claims, the description and the drawings, may be construed being inventive per se or in arbitrary combinations.

LIST OF REFERENCES.

| | |
|---|---|
| 1 | injection molding equipment |
| 10 | first cavity |
| 11 | first gate aperture |
| 12 | first (sealing) needle valve nozzle |
| 13 | first sealing needle |
| 14 | first armature |
| 141 | first armature magnet |
| 15 | first electromagnetic drive |
| 16 | first permanent magnet |
| 17 | first electromagnet |
| 171 | first core |
| 172 | second core |
| 173 | first coil |
| 174 | second coil |
| 18 | first sensor |
| 19 | first nozzle feed duct |
| 20 | second cavity |
| 21 | second gate aperture |
| 22 | second (sealing) needle valve nozzle |
| 23 | second sealing needle |
| 24 | second armature |
| 25 | second electromagnetic drive |
| 26 | second permanent magnet |
| 27 | second electromagnet |
| 28 | second sensor |
| 29 | second nozzle feed duct |
| 30 | control unit |
| 31 | deactivation element |
| 32 | display |
| 33 | operating unit |
| 40 | manifold |
| 50 | excursion stop |
| 51 | opening stop |
| 52 | closing stop |
| 60 | housing |
| A | axis of rotation |
| f1 | first permanent magnet field |
| f2 | second permanent magnet field |
| F1 | first electromagnet field |
| F2 | second electromagnet field |
| I1 | first power pulses |
| I2 | second power pulses |
| IO1 | first opening power pulses |
| IO2 | second opening power pulses |
| IS1 | first closing power pulses |
| IS2 | second closing power pulses |
| L | pulse duration |
| M | flowable material |
| N | magnet north pole |
| S | magnet south pole |
| SG | closed position |
| SO | open position |
| t | time |
| TS | closing time delta |
| TO | opening time delta |

1. A method for operating several sealing-needle valve nozzles (12, 22) in injection-molding equipment (1), characterized by the features below:
the injection-molding equipment (1) comprises at least two cavities (10, 20) and at least one (sealing) needle valve nozzle (12, 22) per cavity (10, 20),
each needle valve nozzle ((12, 22) is fitted with a sealing needle (13, 23) displaceable by means of an electromagnetic drive (15, 25) into an open position (SO) and a closed position (SG) in order to release respectively close a gate aperture (11, 22) subtended in the related cavity (10, 20),
each electromagnetic drive (15, 25) is fitted with at least one electromagnet (17, 27),
each sealing needle (13, 23) is axially kept in the open position (SO) and in the closed position (SG) by at least one permanent magnet (16, 26),
a control unit (30) of the injection-molding equipment (1) generates individual power pulses (I1, I2) for each electromagnetic drive (15, 25) of the needle valve nozzles (12, 22),
the power pulses (I1, I2) evince a defined pulse duration (L) saved in the control unit (30),
a power pulse (I1, I2) fed to the electromagnet (17, 27) of an electromagnetic drive (15, 25) generates an electromagnetic field (F) in order to overcome the force between the sealing needle (13, 23) and the permanent magnet (16, 26) and to displace the sealing needle (13, 23) from the closed position (SG) into the open position (SO) or from the open position (SO) into the closed position (SG),
the power pulses (I1, I2) of at least two electromagnetic drives ((15, 25) are transmitted to these in time-staggered manner.

2. Method as claimed in claim 1, characterized in that the power pulses (I1, I2) fed to an electromagnetic drive (15, 25) are opening power pulses (IO1, IO2) to displace a sealing needle (13, 23) from a closed position (SG) into an open position (SO), or are closing power pulses (IS1, IS2) of opposite current direction to displace a sealing needle (13, 23) from an open position (SO) into closed position (SG), the opening power pulses (IO1, IO2) and/or the closing power pulses (IS1, IS2) being transmitted in time-staggered manner to the electromagnetic drives (15, 25).

3. Method as claimed in claim 2, characterized in that the opening power pulses (IO1, IO2) are transmitted with defined opening time deltas (TO) saved in the control unit (30) and/or that the closing power pulses (IS1, IS2) are transmitted with defined closing time deltas (TS) saved in the control unit (30), in time-staggered manner, to the electromagnetic drives (14, 24).

4. Method as claimed in claim 1, characterized in that the power pulses (IS1, 1S2) are transmitted with defined opening time deltas (TO) and/or with defined closing time deltas (TS) saved in the control unit (30) in time-staggered manner to the electromagnetic drives (15, 25).

5. Method as claimed in claim 3, characterized in that the opening time delta (TO) and/or the closing time delta (TS) are adjusted in such a way in the control unit (30) that during the open position (SO) of the sealing needles (13, 23) the cavities (10, 20) are filled with an ideal quantity of flowable material (M).

6. Method as claimed in claim 3, characterized in that the opening time delta (TO) and/or the closing time delta (TS) are saved in the control unit (30) and evince an accuracy of at least 1/100 seconds.

7. Method as claimed in claim 3, characterized in that a filling-level measurement in the cavities (10, 20) is implemented by sensors (18, 28) and in that the opening time deltas (TO) and/or the closing time deltas (TS) are computed by the control unit (30) and/or adjusted by it.

8. Method as claimed in claim 3, characterized in that separate opening time deltas (TO) and/or closing time deltas (TS) are saved in the control unit (30) for different injection molding scenarios from which one shall be selected.

9. Method as claimed in claim 1, characterized in that each sealing needle (13, 23) is fitted with an armature (14, 24) which cooperates with the permanent magnets (16, 26) and the electromagnets (17, 27).

10. Method as claimed in claim 9, characterized in that each armature (14, 24) is fitted with an armature magnet (241) cooperating with the permanent magnets (16, 26) and with the electromagnets (17, 27).

11. Method as claimed in claim 1, characterized in that the (sealing) needle valve nozzles (11, 21) communicate to allow flow by means of nozzle feed ducts (19, 29) and these ducts communicate by means of a common manifold (40).
